(19) United States
(12) Patent Application Publication
(10) Pub. No.: US 2009/0168038 A1
(43) Pub. Date: Jul. 2, 2009

(54) EXPOSURE APPARATUS, DETECTION METHOD, AND METHOD OF MANUFACTURING DEVICE

(75) Inventor: Akio Akamatsu, Utsunomiya-shi (JP)

Correspondence Address: Locke Lord Bissell & Liddell LLP;Attn: IP Docketing, Three World Financial Center, New York, NY, 10281-2101, US

(73) Assignee: CANON KABUSHIKI KAISHA, Tokyo (JP)

(21) Appl. No.: 12/336,987

(22) Filed: Dec. 17, 2008

(30) Foreign Application Priority Data
Dec. 26, 2007 (JP) 2007-335059

(51) Int. Cl. G03B 27/54; G01B 11/14; G03B 27/32

(52) U.S. Cl. 355/67; 356/620; 355/77

(57) ABSTRACT

An exposure apparatus according to this invention comprises an illumination optical system which illuminates an original with exposure light, a projection optical system which projects an image of the original onto a substrate, an original stage which holds and drives the original, a substrate stage which holds and drives the substrate, and a position detection apparatus which detects the relative position between the original and the substrate. A plurality of different first marks are formed on at least one of the original and a reference plate held on the original stage. The position detection apparatus has a function of selecting a first mark in accordance with the illumination condition from a plurality of first marks, and detecting the relative position between the original and the substrate using the selected first mark and a second mark formed on the substrate stage.

### BACKGROUND OF THE INVENTION

1. Field of the Invention

The present invention relates to an exposure apparatus, a detection method, and a method of manufacturing a device using the exposure apparatus.

2. Description of the Related Art

In recent years, along with dramatic progress in techniques of manufacturing semiconductor devices, micropatterning is also making remarkable progress. Especially, the use of a reduction projection exposure apparatus having a submicron resolution, that is commonly called a stepper, has become a mainstream photofabrication technique. Aiming at further improving the resolution, the numerical aperture (NA) of the optical system is increasing, and the exposure wavelength is shortening.

Along with the shortening of the exposure wavelength, the exposure light source is shifting from the g-line or i-line superhigh pressure mercury lamp to a KrF excimer laser and even to an ArF excimer laser.

Moreover, in order to attain both an improvement in the resolution and the assurance of the depth of focus in exposure, an immersion exposure apparatus which exposes the wafer while the space between the wafer and the projection optical system is filled with a liquid has come on the market.

Along with an improvement in the resolution of the projection pattern, demand also exists for improving the accuracies of wafer surface position detection and relative alignment between the wafer and the mask (reticle) in the projection exposure apparatus. The projection exposure apparatus is required to serve not only as a high-resolution exposure apparatus but also as a high-accuracy position detection apparatus.

From another viewpoint, it is also important that the exposure apparatus has a high throughput. To achieve this object, a two-stage type exposure apparatus is available, which includes a plurality of stages. The two-stage type exposure apparatus has at least two spaces, that is, a measurement space for detecting (aligning and focusing) the wafer position (to be referred to as a “measurement space” hereinafter), and an exposure space for exposure based on the measurement result (to be referred to as an “exposure space” hereinafter). In one method of conveying the wafer to the measurement space and the exposure space, a plurality of driving stages are set and alternately swapped.

The measurement space accommodates an alignment detection system which optically detects alignment marks formed on the wafer. On the basis of the position information from the detection system, the exposure position in the exposure space is determined. A reference mark is formed on each stage because when one stage moves from the measurement space to the exposure space, their relative position must be controlled.

In the measurement space, the alignment detection system measures the reference mark, and detects the alignment marks on the wafer with respect to the reference mark. After that, the stage moves to the exposure space, and the relative position between the reticle and the reference mark is detected in the exposure space, thereby guaranteeing the relative position between the measurement space and the exposure space. Therefore, the two-stage type exposure apparatus must measure the reference mark formed on the stage in the two stations.

After the exposure is completed, the stage moves to the measurement space again, and the positions of the next wafer and the reference mark are detected. As described above, a plurality of wafers are exposed upon repeatedly measuring the reference mark in the two spaces in the order of the measurement space, exposure space, and measurement space.

A method of detecting the reference mark in the exposure space has conventionally been proposed (see Japanese Patent Laid-Open No. 2005-175400). In this method, the reference mark has a pattern including a light transmitting unit which transmits exposure light and a light shielding unit which shields it, and the position of the reference mark is detected based on the amount of light transmitted through the light transmitting unit.

A pattern having an opening portion is also formed on the reticle or a surface equivalent to the reticle (to be referred to as a “reticle reference plate” hereinafter), and the opening portion is illuminated with exposure light. The light transmitted through the opening portion in the reticle or reticle reference plate forms, by the projection optical system, an image of the opening portion in the reticle or reticle reference plate on the reference mark formed on the wafer stage. The opening portion of the reference mark is changed relative to the image of the opening portion (with regard to the two-dimensional directions and vertical direction). This changes the amount of light transmitted through the opening portion of the reference mark. On the basis of a profile indicating this change (to be referred to as a “light amount change profile” hereinafter), the relative position between the wafer stage and the reticle or reticle reference plate is detected (to be referred to as “the reference mark is measured” hereinafter).

Such relative alignment between the wafer stage and the reticle or reticle reference plate is not particularly limited to the above-described two-stage type exposure apparatus, and is often used for a single-stage type exposure apparatus. In this case, this alignment is used for measurement of the position, in exposure, of a position detection system which detects the marks on the wafer, and focus calibration for performing the so-called base line measurement and aligning the wafer stage with the image plane of the projection optical system.

From the viewpoint of the throughput, the exposure apparatus must ensure as high a performance as possible. For this purpose, it is necessary to minimize the time taken to measure the relative position between the wafer stage and the reticle or reticle reference plate.

Especially in the two-stage type exposure apparatus, the reference mark need be measured for each wafer, which exerts a large influence on the throughput.

FIGS. 3A and 3B are schematic views showing opening portions (to be referred to as “calibration marks” hereinafter) formed on the reticle or reticle reference plate. Position correction marks (to be referred to as “calibration mark groups” hereinafter) 24 are formed on a reticle 2 or reticle reference plates 17 and 18, as shown in FIG. 3A. FIG. 3B is a view showing details of a calibration mark group 24a shown in FIG. 3A. An opening portion (calibration mark) 601 for measuring the position in the X direction, and an opening portion (calibration mark) 602 for measuring the position in the Y direction are formed in the calibration mark group 24a to align themselves in the directions shown in FIG. 3B.

Reference numeral 4a in FIG. 4 shows reference mark side calibration marks corresponding to the calibration marks on the reticle or reticle reference mark when the reference mark formed on the wafer stage is observed from the Z-axis direction (viewed from above the reticle side). That is, reference mark side calibration marks 21 and 22 are formed in correspondence with the calibration marks 601 and 602, respectively.

Reference numeral 4b in FIG. 4 is a schematic view when the reference mark is observed from its sectional direction. Referring to 4b in FIG. 4, opening portions (reference mark side calibration marks) 31 and 32 are formed in correspondence with the calibration marks 601 and 602, respectively. The light transmitted through the reference mark side calibration marks 31 and 32 enters photoelectric conversion elements 33 and 33′, which detect the light amounts. The photoelectric conversion elements 33 and 33′ can individually detect the light amounts so as to separably detect even light which enters both the reference mark side calibration marks 31 and 32 at once. Although the photoelectric conversion elements 33 and 33′ are individual sensors, they may be a common sensor. In this case, the common sensor detects light beams in both the X and Y directions at once.

Position detection is desirably performed by illuminating the calibration marks 601 and 602 on the reticle 2 or reticle reference plates 17 and 18 under illumination conditions for use in actual exposure. This is to prevent a decrease in throughput by the time taken to switch the illumination conditions. The illumination conditions include herein, for example, the illumination distribution in the exposure light illumination region, and the illumination distribution and the light distribution characteristic of the effective light source. The illumination conditions also include an illumination scheme of inserting a stop at an off-axis position along the optical axis, and obliquely irradiating the photomask with an exposure light beam in order to improve the resolution and the depth of focus, that is, the so-called modified illumination. Note that the effective light source the light intensity distribution on the pupil plane of the illumination optical system, and also means the angular distribution of light which strikes the irradiation target surface.

The measurement of the relative position between the reticle and the wafer stage described above has conventionally been performed using both the calibration mark 601 for measuring the position in the X direction, and the calibration mark 602 for measuring the position in the Y direction, irrespective of the illumination conditions.

The focus calibration can be performed using the reference mark by setting the average of the detection results obtained by using the X- and Y-direction marks 601 and 602 formed at two points on the reticle 2 as a best focus position of the projection optical system.

However, if the focus calibration is performed by dipole illumination, measurement in both the X and Y directions is unnecessary because the dipole illumination is an illumination condition to improve the resolution in one of the X and Y directions. However, the prior art sets the average of the detection results obtained by using the X- and Y-direction marks as a final detection result irrespective of the illumination conditions, leading to unnecessary measurement.

For example, a case in which dipole illumination is used in order to improve the resolution in the X direction and increase the depth of focus will be considered. Under this condition, the object can be satisfactorily achieved by position detection using only the calibration mark in the X direction in calibration along the focus direction (Z direction). It is therefore unnecessary to detect the focus position using the calibration mark in the Y direction.

Also in this case, the focus measurement accuracy of the Y-direction mark is poorer than that of the X-direction mark. For this reason, if the average of the focus measurement values in both the X and Y directions is set as a true value, a deviation from the true value often becomes large due to the influence of the measurement accuracy of the Y-direction mark.

In other words, the throughput and measurement accuracy can be improved by performing only measurement in the X direction and not performing unnecessary measurement in the Y direction.

The exposure apparatus is required to have a higher throughput in order to improve productivity. Under the circumstances, improving focus calibration accuracy and shortening measurement time is a serious challenge.

An optimum mark shape, for example, an optimum width of the opening portion (to be referred to as the “slit width” hereinafter) and an optimum interval of the opening portion (to be referred to as the “slit interval” hereinafter) change depending upon the illumination conditions. However, measurement in the prior art is performed by always using the same mark shape irrespective of the illumination conditions, so optimal accuracy cannot always be guaranteed.

### SUMMARY OF THE INVENTION

It is an object of the present invention to improve the accuracy of detection of the relative position between an original and a substrate.

According to the first aspect of the present invention, there is provided an exposure apparatus comprising an illumination optical system which illuminates an original with exposure light, a projection optical system which projects an image of the original onto a substrate, an original stage which holds and drives the original, a substrate stage which holds and drives the substrate, and a position detection apparatus which detects a relative position between the original and the substrate,

wherein a plurality of different first marks are formed on at least one of the original and a reference plate held on the original stage, and

the position detection apparatus has a function of selecting a first mark in accordance with an illumination condition from the plurality of first marks, and detecting the relative position between the original and the substrate using the selected first mark and a second mark formed on the substrate stage.

According to the second aspect of the present invention, there is provided a detection method of detecting an image location of light which exits from an illumination optical system which illuminates an original, and is transmitted through a projection optical system which projects an image of the original onto a substrate, the method comprises:

a setting step of setting an illumination condition of the illumination optical system;

a selection step of selecting at least one first mark in accordance with the set illumination condition from a first mark group including a plurality of first marks which have different patterns and are formed on at least one of the original and an original stage which holds the original; and

a detection step of detecting the image location by changing a relative position between the first mark selected in accordance with the set illumination condition and a second mark formed on a substrate stage which holds the substrate, while projecting the pattern of the first mark onto the second mark.

According to the third aspect of the present invention, there is provided a detection method of detecting an image location of light which exits from an illumination optical system which illuminates an original, and is transmitted through a projection optical system which projects an image of the original onto a substrate, the method comprises:

a setting step of setting an illumination condition of the illumination optical system;

a first selection step of selecting at least one first mark from a first mark group including a plurality of first marks which have different patterns and are formed on at least one of the original and an original stage which holds the original; and

a first detection step of detecting the image location by changing a relative position between the first mark selected in accordance with the set illumination condition in the first selection step and a second mark formed on a substrate stage which holds the substrate, while projecting the pattern of the first mark onto the second mark;

a second selection step of selecting, from the first mark group, at least one first mark different from the first mark selected in the first selection step;

a second detection step of detecting the image location by changing a relative position between the first mark selected in accordance with the set illumination condition in the second selection step and the second mark, while projecting the pattern of the first mark onto the second mark; and

a determination step of determining a true image position for the illumination condition by comparing at least the image location obtained in the first detection step and the image location obtained in the second detection step.

According to the present invention, it is possible to improve the accuracy of detection of the relative position between an original and a substrate.

Further features of the present invention will become apparent from the following description of exemplary embodiments with reference to the attached drawings.

### BRIEF DESCRIPTION OF THE DRAWINGS

FIG. 1 is a schematic view showing a single-stage type exposure apparatus according to the first embodiment;

FIG. 2 is an explanatory view showing the base line in the single-stage type exposure apparatus;

FIG. 3A is a view showing the arrangement of a calibration mark group on a reticle;

FIG. 3B is a view showing the arrangement of the calibration mark group on the reticle;

FIG. 4 shows schematic views showing a reference mark;

FIG. 5 is a graph showing a light amount change profile;

FIG. 6 is a schematic view showing a two-stage type exposure apparatus according to the first embodiment;

FIG. 7 is a schematic view showing dipole illumination which illuminates the surface of the reticle;

FIG. 8A is a view showing the arrangement of marks on a reticle according to the second embodiment;

FIG. 8B is a view showing the arrangement of the marks on the reticle according to the second embodiment;

FIG. 8C is a view showing the arrangement of the marks on the reticle according to the second embodiment;

FIG. 9 is a graph showing a light amount change profile obtained from a reference mark according to the second embodiment;

FIG. 10A is a graph showing a light amount change profile obtained from the reference mark according to the second embodiment;

FIG. 10B is a graph showing a light amount change profile obtained from the reference mark according to the second embodiment;

FIG. 11 is a graph showing a light amount change profile obtained from the reference mark according to the second embodiment;

FIG. 12 is a graph showing a light amount change profile obtained from the reference mark according to the second embodiment;

FIG. 13 is a graph showing a light amount change profile obtained from the reference mark according to the second embodiment; and

FIG. 14 is a view illustrating an example of stops.

### DESCRIPTION OF THE EMBODIMENTS

In embodiments of the present invention, a plurality of first marks are formed on a reticle or reticle reference plate held on an original stage (reticle stage), and a second mark is formed on a substrate stage (wafer stage). In the following description, the plurality of first marks will be referred to as a calibration mark group, and the second mark will be referred to as a reference mark. A plurality of marks having different shapes are formed as the reference mark and calibration mark group, thereby detecting the position of the reference mark. In this case, the throughput can be improved and the accuracy can be increased by optimizing a method of selecting a calibration mark for use in the measurement from the plurality of calibration marks formed on the reticle or reticle reference plate.

More specifically, one of two marks having different directions, for example, is selected in accordance with the illumination conditions, and the relative position between the original and the movable stage is detected. At this time, the characteristic of a light amount change profile that depends on the illumination conditions and mark shape is used as a selection criterion. This allows high-throughput, high-accuracy detection.

In an example, a plurality of marks including slits having different directions, different dimensions in the shorter directions (widths), and different intervals are formed as a calibration mark group on a reticle. For example, a total of six types of marks are formed when their slits have two directions, that is, the X and Y directions, and three combinations of the widths and intervals. Marks corresponding to these marks are also formed on the reference mark. If, for example, the illumination condition is dipole illumination, only a calibration mark in a direction, in which the resolution increases upon dipole illumination as compared with that under a normal illumination condition, of the X- and Y-direction marks having different slit directions is used for the focus detection. In addition, calibration marks having different slit widths are measured, and their light amount change profiles are evaluated, thereby selecting an optimum silt width. The throughput improves by detecting the reference mark using one of the X- and Y-direction marks. Also, the alignment accuracy improves by detecting the reference mark with an optimum slit width. In other words, high-throughput, high-accuracy detection can be done by selecting one of the plurality of calibration marks formed on the reticle in accordance with the illumination conditions, and detecting the position of the reference mark using the selected calibration mark.

In this manner, the relative positions between the reticle stage side calibration mark group and the wafer stage side reference mark can be detected with a high throughput and high accuracy by appropriately using the calibration marks in accordance with the illumination conditions.

Embodiments of the present invention will be described below with reference to the accompanying drawings.

### First Embodiment

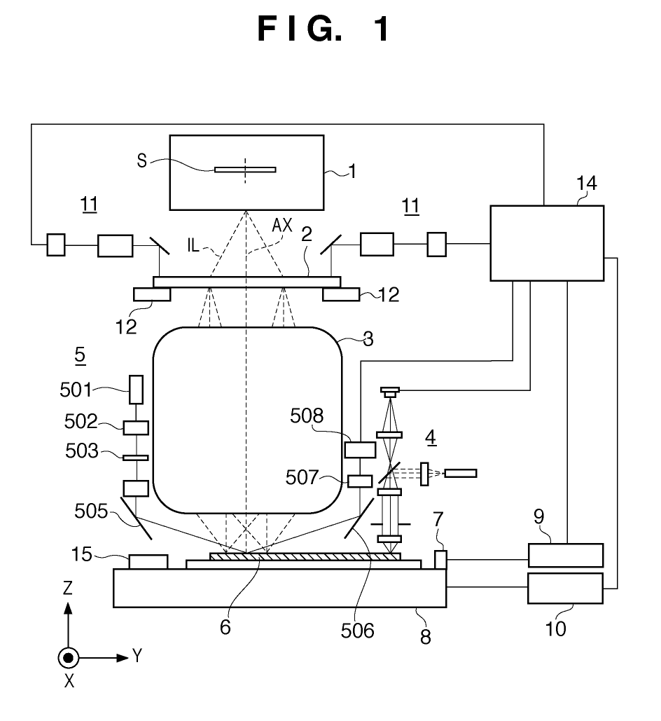

The outline of a single-stage type exposure apparatus will be explained with reference to FIG. 1. Light emitted by an illumination optical system 1 which performs illumination with exposure light illuminates a reticle 2 arranged with reference to a reticle set mark 12 formed on a reticle stage (not shown). The reticle 2 is aligned by a reticle alignment detection system 11 which allows simultaneous observation of the reticle set mark 12 on the reticle stage and a reticle set mark (not shown) formed on the reticle 2.

The light transmitted through the pattern on the reticle 2 forms an image on a wafer 6 by a projection optical system 3, thereby forming an exposure pattern on the wafer 6. The wafer 6 is held on a wafer stage 8 which can be driven in the X, Y, and Z directions and rotation directions. A base line measurement reference mark 15 (to be described later) is formed on the wafer stage 8.

Alignment marks (not shown) are formed on the wafer 6, and their positions are measured by a dedicated position detector 4. The position of the wafer stage 8 is always measured by an interferometer 9 which refers to an interferometer mirror 7. On the basis of the measurement result obtained by the interferometer 9, and the alignment mark measurement result obtained by the position detector 4, the arrangement information of a chip formed on the wafer 6 is calculated. Note that because no alignment marks are formed on the wafer to be exposed first, the design information of the chip arrangement can be used as the chip arrangement information.

Also, since the wafer 6 must be aligned with respect to the focus position of the image formed by the projection optical system 3 in exposing the wafer 6, a focus detection system 5 which detects the position of the wafer 6 in the focus direction is arranged. Light which exits from a light source 501 passes through an illumination lens 502, slit pattern 503, and mirror 505 to obliquely project the slit pattern onto the wafer 6. The slit pattern projected onto the wafer 6 is reflected by the wafer surface, and reaches a photoelectric conversion element 508 such as a CCD by a detection lens 507 set on the opposite side of the wafer 6. On the basis of the position of an image of the slit pattern obtained by the photoelectric conversion element 508, the position of the wafer 6 in the focus direction can be measured.

The exposure apparatus includes a position detection apparatus having a function of detecting the relative position between the reticle and the wafer. The position detection apparatus includes, for example, a controller 14, the position detector 4 controlled by a control unit of the controller 14, and the focus detection system 5. The position detection apparatus (the control unit of the controller 14) selects a calibration mark optimum for the illumination conditions used from a calibration mark group 24a, as will be described later.

In this manner, the position detector 4 detects the arrangement information of a chip formed on the wafer 6. Prior to this detection, the relative positional relationship (base line) between the position detector 4 and the reticle 2 must be obtained.

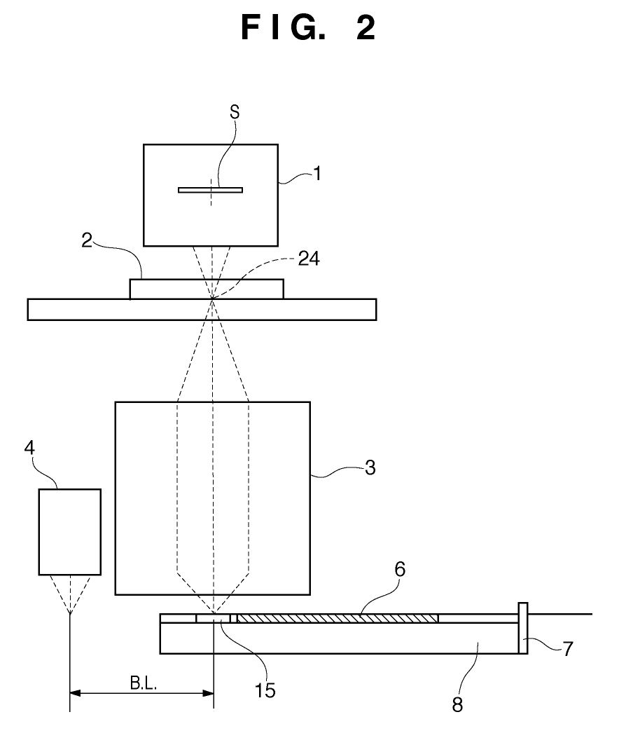

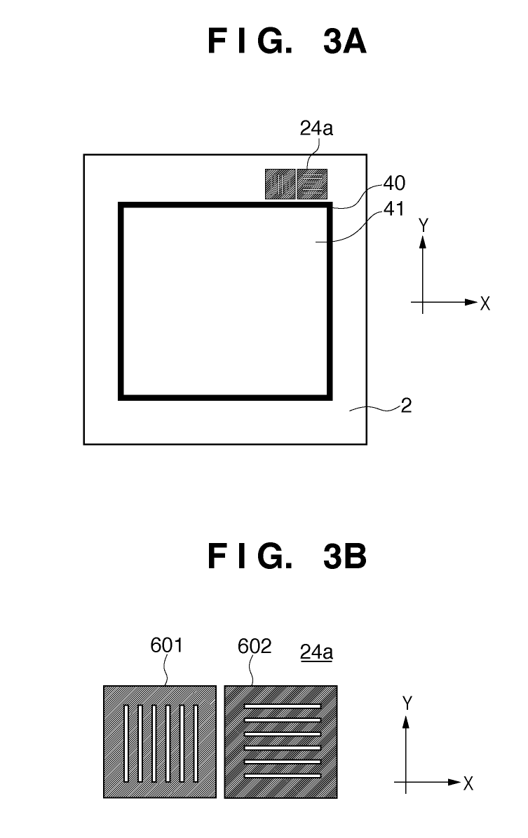

The outline of a method of measuring the base line will be explained with reference to FIGS. 2, 3A, 3B, and 4. FIG. 3A shows the calibration mark group 24a formed on the reticle 2. FIG. 3B explains details of the calibration mark group 24a shown in FIG. 3A. A calibration mark 602 for measuring the position in the Y direction, and a calibration mark 601 for measuring the position in the X direction are formed in the calibration mark group 24a to align themselves in the directions shown in FIG. 3B. The calibration mark 602 is formed as a pattern in which a slit whose longitudinal direction is the X direction and a light shielding unit are formed repetitively. The calibration mark 601 is formed as a mark including slits which parallelly extend in the Y direction perpendicular to the slit direction of the calibration mark 602.

Although measurement marks in the X and Y directions on the X-Y coordinate system defined as in FIGS. 3A and 3B are exemplified in this embodiment, the present invention is not particularly limited to this. For example, measurement marks tilted at 45° or 135° with respect to the X- and Y-axes may be formed. The directions of the marks are therefore not particularly limited to those in this embodiment.

Exposure light illuminates the calibration marks 601 and 602 by the illumination optical system 1. The light transmitted through the calibration marks 601 and 602 forms an image of the opening pattern at a best focus position on the wafer side by the projection optical system 3.

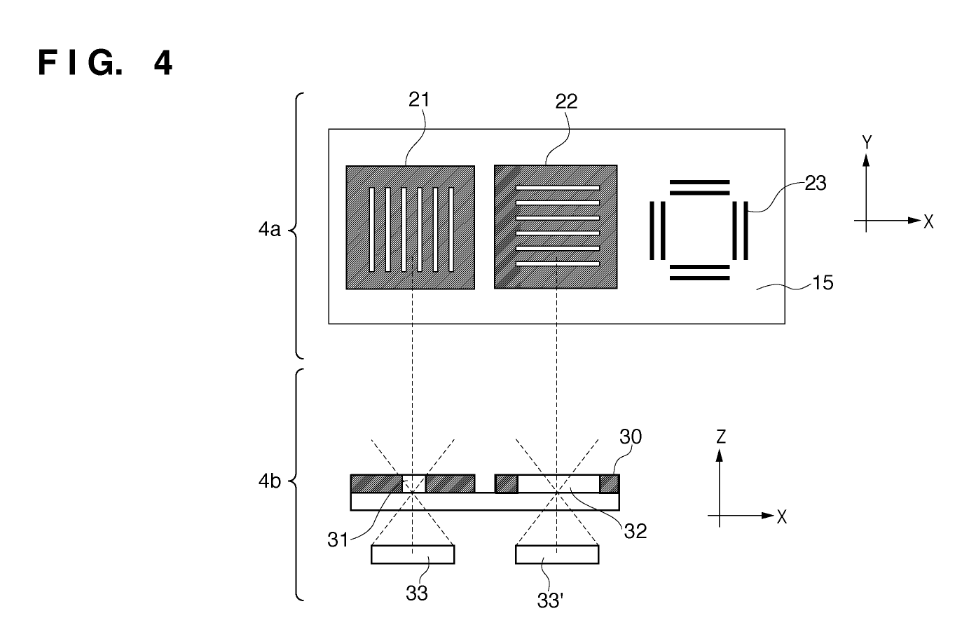

The reference mark 15 is formed on the wafer stage 8. The reference mark 15 will be explained in detail with reference to FIG. 4. FIG. 4 shows part of a detection unit which detects the relative position between the reticle and the wafer stage. The reference mark 15 has opening patterns (reference mark side calibration marks) 21 and 22 having the same sizes as those of projected images of the calibration marks 601 and 602 on the reticle 2 described above. Reference numeral 4b in FIG. 4 shows the reference mark 15 viewed from its sectional direction. Each of the reference mark side calibration marks 21 and 22 is formed from a light shielding unit 30 having a light shielding characteristic for the exposure light, and a plurality of slits (reference mark side calibration marks) 31 and 32 (only one opening portion is shown in 4b of FIG. 4 for each mark). The light which illuminates the calibration mark selected by the control unit and is transmitted though the reference mark side calibration marks 31 and 32 reaches photoelectric conversion elements 33 and 33′ set under the reference mark 15. The photoelectric conversion elements 33 and 33′ can measure the intensities of the light beams transmitted through the reference mark side calibration marks 31 and 32. On the basis of the intensities of the light beams from the illuminated calibration marks 31 and 32, the relative position between the reticle and the wafer stage is detected.

In addition to the reference mark side calibration marks 21 and 22 corresponding to the calibration marks 601 and 602, a position measurement mark 23 which can be detected by the position detector 4 is formed on the reference mark 15. The position of the position measurement mark 23 is obtained on the basis of the result of detection of the position measurement mark 23 by the position detector 4 by driving the position measurement mark 23 to the observation region of the position detector 4, and the measurement result simultaneously obtained by the interferometer.

A method of obtaining the position of the position detector 4 relative to the projection optical system (the base line indicated by B.L. in FIG. 2) using the reference mark 15 described above will be explained in detail next. First, the calibration marks 601 and 602 formed on the reticle 2 are driven to predetermined positions through which the exposure light for the projection optical system 3 propagates. Note that the following description will be given by taking the calibration mark 601 as an example. This is because the same applies to the other calibration mark 602.

The illumination optical system 1 illuminates with exposure light the calibration mark 601, which is driven to the predetermined position. The illumination optical system 1 includes a mechanism (not shown) which switches the illumination shape to be able to select appropriate illumination conditions in accordance with the exposure pattern. FIG. 14 illustrates an example of stops S as part of the mechanism which switches the illumination shape. FIG. 14 shows a structure in which seven stops are formed on a single disk, and they are switched as the disk rotates. Stops indicated by a, c, and e set a normal high-σ illumination condition, those indicated by b and d set dipole illumination, that indicated by f sets minimum-σ illumination, and that indicated by g sets cross-pole illumination. Note that σ means herein the ratio of a region through which the illumination light is transmitted to the NA of the projection optical system (a value obtained by dividing the NA of the projection optical system on its incident side by that of the illumination optical system on its exit side). Letting σ1 be the ratio when the illumination light is transmitted through the projection optical system by its Full-NA (maximum NA), a ratio σ close to σ1is defined to be high. Letting σ0 be the ratio when the illumination light is not transmitted through the projection optical system, a ratio σ close to σ0 is defined to be low.

The light transmitted through the light transmitting unit of the calibration mark 601 forms a mark pattern image at the image location on the wafer using the projection optical system 3. The reference mark side calibration mark 21 having the same shape as that of the mark pattern image is set at a position matching that of the mark pattern image by driving the wafer stage 8. At this time, while the reference mark 15 is inserted on the image plane (best focus plane) of the calibration mark 601, the output value of the photoelectric conversion element 33 is monitored while driving the reference mark side calibration mark 21 in the X direction.

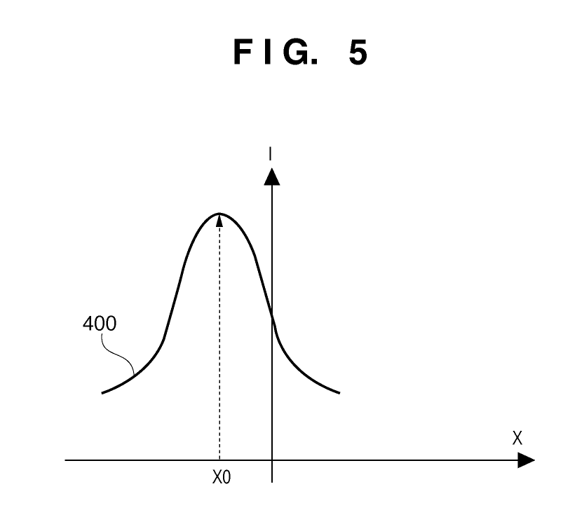

FIG. 5 is a plot depicting the position of the reference mark side calibration mark 21 in the X direction and the output value of the photoelectric conversion element 33. Referring to FIG. 5, the abscissa indicates the position of the reference mark side calibration mark 21 in the X direction, and the ordinate indicates an output value I of the photoelectric conversion element 33. In this manner, as the relative position between the calibration mark 601 and the reference mark side calibration mark 21 changes, the obtained output value, in turn, changes. Of plotted positions that indicate a change (to be referred to as a “light amount change profile” hereinafter) 400 in the output value for the relative position between these calibration marks, a position X0 at which the light transmitted through the calibration mark 601 matches the slits of the reference mark side calibration mark 21 corresponds to a maximum light amount. Obtaining the matched position X0 makes it possible to obtain the position of a projected image of the calibration mark 601 on the wafer side, which is formed by the projection optical system 3. A stable, accurate measurement value of the detection position X0 can be calculated by obtaining the peak position of the obtained light amount change profile 400 in a predetermined region by, for example, barycenter calculation or function approximation.

The above description has been given assuming measurement using the calibration mark 601. However, the same detection operation using a slit pattern corresponding to the calibration mark 602 makes it possible to detect the position of a projected image of the calibration mark 602, which is formed by the projection optical system 3.

Although the above description has been given assuming that the reference mark 15 is set on a best focus plane of a projected image, the wafer position in the focus direction (Z direction) is often misaligned in an actual exposure apparatus. A best focus plane can be obtained by monitoring the output value of the photoelectric conversion element 33 while driving the reference mark 15 in the Z direction at the position X0. In the graph shown in FIG. 5, a best focus plane can be calculated by the same process by defining the abscissa as the focus position, and the ordinate as the output value I.

If the reference mark 15 has deviated not only in the X and Y directions but also in the Z direction, its position in one of these directions is measured and obtained with a predetermined accuracy, and its position in another direction is detected. By alternately repeating this process, an optimum position of the reference mark 15 can eventually be calculated. For example, the reference mark 15 is driven in the X direction while being deviated in the Z direction, and its position in the X direction is measured with low accuracy to calculate its approximate position in the X direction. At this position, the reference mark 15 is driven in the Z direction, and a best focus plane is calculated. On the best focus plane, the reference mark 15 is driven in the X direction again, and its position in the X direction is measured. This makes it possible to obtain an optimum position of the reference mark 15 in the X direction with high accuracy. Normally, one alternate measurement as in this case suffices for high-accuracy measurement. Although measurement in the X direction is started first in the above-described example, high-accuracy measurement is eventually possible even by performing measurement in the Z direction first.

The characteristic of the light amount change profile is known to change when the shape of the calibration mark is changed, that is, when the dimension of the slits in the shorter direction (slit width) or the interval of the slits (slit interval) of the mark is changed. Note that the light amount change profile refers to a profile indicating a change in the amount of light transmitted through the calibration mark group and reference mark upon changing the position of the wafer stage. For example, increasing the slit width increases the depth of focus and therefore allows measurement in the X direction even when the reference mark is largely deviated in the Z direction. On the other hand, decreasing the slit width improves the contrast of the light amount change profile. Changing the slit interval makes it possible to change the maximum amount of transmitted light. The output value and contrast serve herein as parameters to obtain a stable, accurate measurement value in calculating the peak position of the obtained light amount change profile in a predetermined region by, for example, barycenter calculation or function approximation.

As described above, after the positions of projected images of the calibration marks 601 and 602 in the X and Y directions are calculated, the reference mark 15 is driven to the side of the position detector 4, and the position of the position measurement mark 23 is detected. The use of the driving amount of the wafer stage 8 and the detection result obtained by the position detector 4 allows the calculation of the relative position (base line) between the projection optical system 3 (reticle 2) and the position detector 4. Furthermore, the position detection apparatus detects the relative position between the reticle and the wafer on the basis of the chip arrangement information.

The above-described base line measurement is performed in a so-called single-stage type exposure apparatus including only one wafer stage. On the other hand, a multiple-stage type exposure apparatus including two (a plurality of) wafer stages uses the reference mark 15 to detect the relative position between the position detector 4 and each calibration mark projected by the projection optical system 3, although the relative position in this case is not the base line.

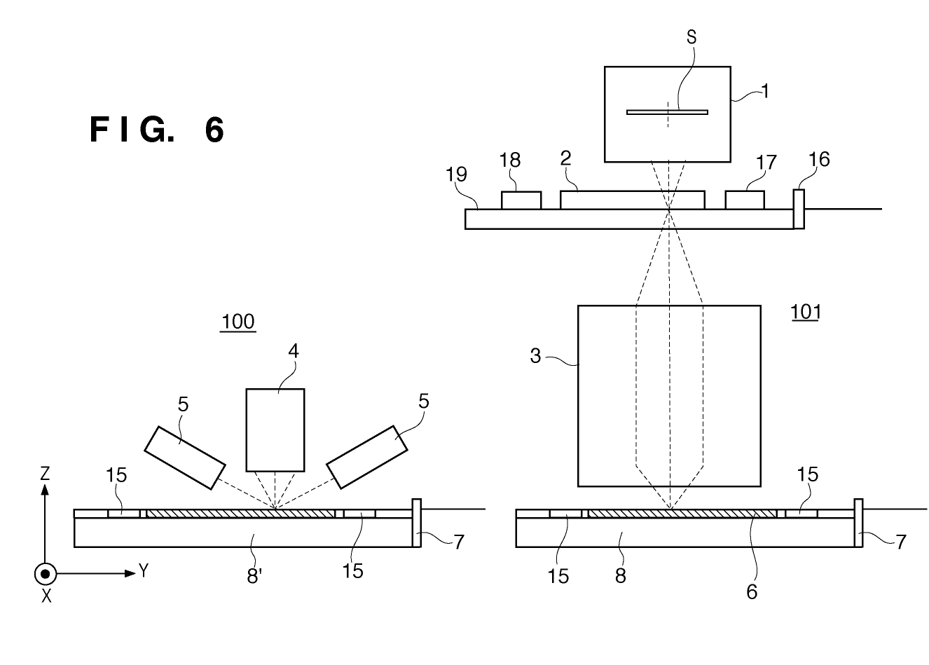

FIG. 6 is a schematic view showing a two-stage type exposure apparatus. How to use the reference mark 15 will be explained with reference to FIG. 6.

The two-stage type exposure apparatus has two divided regions, that is, a measurement space 100 for measurement such as wafer alignment and focusing, and an exposure space 101 for exposure based on the measurement result. The two wafer stages are alternately swapped between these spaces, and measurement and exposure are repeated. The reference mark 15 and the like formed on the wafer stage 8 are the same as those described above.

In the measurement space 100, the position detector 4 calculates the position of the position measurement mark 23 on the reference mark 15. Alignment marks (not shown) formed on the wafer 6 with respect to this position are similarly detected, and the arrangement information of a chip formed on the wafer 6 is calculated. In other words, the chip arrangement information with respect to the reference mark 15 is calculated and stored in the apparatus. Likewise, the level of the wafer 6 relative to the position of the reference mark 15 in the focus direction, in other words, the Z direction, is detected. More specifically, the position of the reference mark 15 in the Z direction is detected by the focus detection system 5. Next, the wafer stage 8 is driven in the X and Y directions, and the position of the entire surface of the wafer 6 in the Z direction is detected. On the basis of this measurement result, the position of the wafer 6 in the Z direction relative to the position of the wafer stage 8 in the X and Y directions is calculated and stored in the apparatus. The calculation of the position in the Z direction relative to the position in the X and Y directions will be referred to as focus mapping hereinafter. This focus mapping is also performed with reference to the position of the reference mark 15.

As described above, both the chip arrangement information and focus mapping information are obtained with respect to the reference mark 15 in the measurement space 100. The wafer stage 8 is moved to the exposure space while the relative position between the reference mark 15 and the wafer remains the same.

The relative position between the reference mark 15 formed on the wafer stage 8, which was moved, and each calibration mark formed on the reticle 2 is obtained. The calculation method is the same as described above. In this manner, because obtaining the relative position (in the X, Y, and Z directions) between the reticle 2 and the reference mark 15 amounts to obtaining the relative position between the reference mark 15 and the wafer 6, information on the relative position between the reticle 2 and each chip on the wafer 6 is obtained. On the basis of this information, an exposure operation is started.

As described above, even the two-stage type exposure apparatus detects the relative positions between the calibration marks 601 and 602 formed on the reticle 2 and the reference mark side calibration marks 21 and 22 on the reference mark 15. In the single-stage type exposure apparatus, it is a common practice to perform this calibration mark measurement as the base line measurement as needed. This is because when the relative position between the projection optical system 3 and the position detector 4 is stable, the relative positions between these marks theoretically do not change once the measurement is performed. Throughput performance is an important factor for the exposure apparatus, so the frequency of such base line measurement must be minimized.

In the two-stage type exposure apparatus, the position of the wafer stage 8 is often misaligned (often does not meet a required accuracy) as the wafer stage 8 moves from the measurement space 100 to the exposure space 101. This makes it necessary to perform the above-described calibration mark measurement for each wafer. From the viewpoint of the throughput, the time taken for the calibration mark measurement must be minimized.

To achieve this object, it is necessary to detect the relative position using only a calibration mark optimum for the illumination conditions, instead of using all the calibration marks 601 and 602 shown in FIG. 3B for the detection without taking account of the illumination conditions.

The illumination conditions and the selection conditions of the calibration marks on the reticle 2 from the viewpoint of attaining a high throughput will be explained below. This embodiment will disclose a method of selecting a calibration mark suitable for attaining a high throughput.

A method of arranging the calibration marks will be explained by referring back to FIGS. 3A, 3B, and 4. Referring to FIG. 3A, an exposure area 41 in which an actual element pattern is formed in a light shielding zone 40 is set. A calibration mark group 24a is set around the light shielding zone 40.

Although a method of selecting marks in the X and Y directions has been described above, the present invention is not particularly limited to this. For example, measurement marks tilted at 45° or 135° with respect to the X- and Y-axes may be formed. The directions of the marks are therefore not particularly limited to those in this embodiment. Also, a plurality of calibration marks need not always be grouped, and the positions and the number of sets of a plurality of calibration marks are not particularly limited. In this embodiment, it is necessary that a plurality of calibration marks having different shapes can be selected in accordance with the illumination conditions.

The exposure apparatus often uses an illumination technique of tilting illumination light that has perpendicularly irradiated the reticle, thereby increasing the resolution and the depth of focus, that is, the so-called modified illumination.

The modified illumination is attained by, for example, inserting stops as shown in FIG. 14, or a diffractive optical element such as a prism or CGH into the illumination optical system. The tilting of the illumination light changes the directions of first- and 0th-order light components generated by the reticle. This makes it possible to transmit light diffracted by a pattern finer than the conventional resolution limit through the projection optical system, thus attaining an improvement in the resolution. It is also possible to increase the depth of focus of a projected image of the pattern, thus attaining an improvement in the manufacturing yield of semiconductor devices.

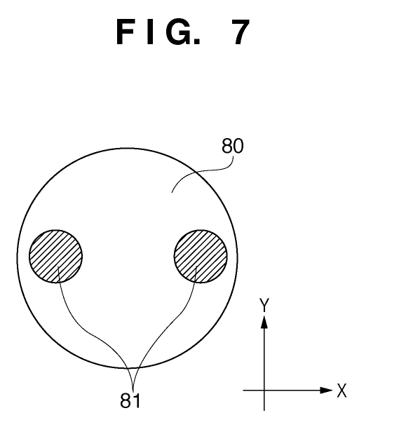

Examples of a stop for use in the modified illumination are the one for use in annular illumination which circularly transmits light, and the one for use in dipole illumination (FIG. 7) which transmits light through two holes.

A case in which the illumination condition is dipole illumination will be exemplified. FIG. 7 is a schematic view showing dipole illumination. A dipole illumination region 81 is attained by transmitting light through two circular holes by a special stop in a maximum illumination region 80.

Referring to FIG. 7, two effective illumination regions for dipole illumination are juxtaposed along the X direction. In this case, the resolution of a pattern element, which extends in the Y direction, of a pattern to be actually transferred by exposure must be improved, and the depth of focus of this pattern element must be increased. For this reason, the object of calibration in the focus direction (Z direction) can be satisfactorily achieved by position detection using only the calibration mark in the X direction. Focus position detection using the calibration mark in the Y direction is therefore unnecessary.

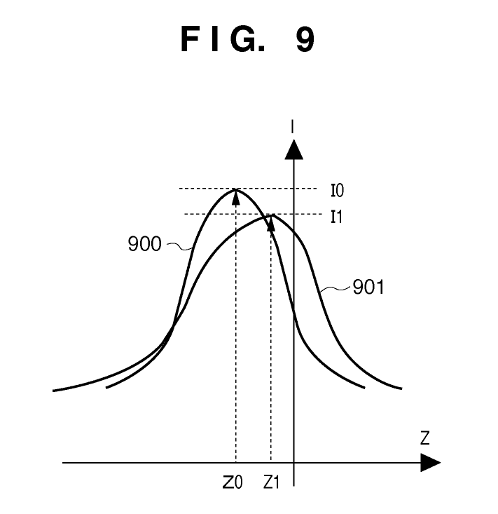

Also in this case, the focus measurement accuracy of the Y-direction mark is poorer than that of the X-direction mark. If the average of the focus measurement values in both the X and Y directions is determined as a focus value to match in exposure (to be referred to as a “true value” hereinafter), a deviation from the true value often becomes large due to the influence of the measurement accuracy of the Y-direction mark. A deviation from the true value of the focus position detection described above will be explained by taking the case shown in FIG. 9 as an example. Note that a light amount change profile 900 is assumed as the result of detecting the calibration mark in the X direction, and a light amount change profile 901 is assumed as the result of detecting the calibration mark in the Y direction. According to the object under the above-described illumination condition, the true value is a detection result Z0 obtained by the light amount change profile 900. However, a deviation from the true value occurs upon taking account of a detection result Z1 obtained by the light amount change profile 901.

For example, a difference of about 10 nm often occurs between the focus values of the detection results Z0 and Z1, depending upon the aberration of the projection optical system. If the average of the focus values is set as the true value, a calibration error (offset) of 5 nm occurs. Hence, in the dipole measurement of this example, measurement of only the detection result Z0 allows appropriate position detection.

In this manner, focus measurement only in the X direction makes it possible to attain improvements in both the throughput and measurement accuracy because unnecessary focus measurement in the Y direction is omitted.

Alignment on the X-Y plane requires position detection using the calibration marks in both the X and Y directions. In view of this, calibration in the focus direction is performed by position detection using only the calibration mark in the X direction, and alignment on the X-Y plane is performed by position detection using the calibration marks in both the X and Y directions.

As described above, the use of only a calibration mark in a direction necessary for dipole illumination allows an improvement in throughput and an increase in accuracy.

The throughput can be further improved by storing mark shapes optimum for respective illumination conditions in the storage unit of the controller 14 and referring to the storage unit, thereby measuring the position of the reference mark using information on a mark shape selected once.

The throughput can also be further improved by selecting, in advance, a mark shape optimum for the illumination conditions used, on the basis of the simulation value of a light amount change profile obtained by measuring the position of the reference mark.

Although the above description has been given assuming that the calibration marks 601 and 602 are formed on the reticle 2, the present invention is not particularly limited to this. For example, a scan stage type exposure apparatus can also drive a reticle stage 19 on the side of the reticle 2. Calibration marks 601 and 602 may be formed on reticle reference plates 17 and 18 that are made of members equivalent to that of the reticle 2 and fixed at positions different from that of the reticle 2 on the reticle stage 19. The use of even the calibration marks 15 on the reticle reference plates 17 and 18 similarly allows measurement on the wafer side.

It is also possible to form a plurality of calibration marks on both the reticle 2 and the reticle reference plates 17 and 18 so that an appropriate one of these marks can be selected.

The relative positions between the reference mark 15 and the reticle reference plates 17 and 18 are detected not only to detect the position of the wafer stage 8 but also to measure, for example, the optical performance (aberration) of the projection optical system 3. Because this measurement can be performed by always using the same reticle reference plates, there are merits of, for example, facilitating the detection of a temporal change and the like, and eliminating the adverse influence of the drawing accuracy of the pattern of the reticle 2.

Although the selection of a set of X- and Y-direction marks has been exemplified in this embodiment, a plurality of sets of X- and Y-direction marks may be selectively used. For example, forming a plurality of sets of marks at different positions along the X direction on the reticle makes it possible to measure a change in the focus position in the X direction, in other words, to measure the so-called tilt and field curvature of the image plane of the projection optical system, and to measure the magnification and distortion of the image plane of the projection optical system in the X direction.

### Second Embodiment

Depending on the illumination conditions, the throughput and detection accuracy can be improved by optimizing the shapes of calibration marks and reference mark side calibration marks. The illumination conditions include herein not only the modified illumination described previously but also the general optical conditions such as the illumination distribution and light distribution of the effective light source, and the numerical aperture (NA) of the illumination optical system 1.

Assume that a light amount change profile 900 as shown in FIG. 9 is obtained to calculate a best focus plane by monitoring the output value of a photoelectric conversion element 33 while driving a reference mark 15 in the Z direction. However, depending on the illumination conditions, for example, illumination conditions under which illumination nonuniformity occurs or those under which the pole balance is poor, the light amount change profile suffers a distortion as indicated by reference numeral 901. When this occurs, a true value Z0 shifts to a value Z1, resulting in deterioration in alignment accuracy. In addition, the use of a light amount change profile obtained under illumination conditions under which the overall light amount is small leads to deterioration in true value detection accuracy. The use of a light amount change profile having a plurality of peaks leads with very high probability to erroneous detection.

In optimizing the light amount change profile by switching the illumination conditions, the throughput decreases by the time taken to switch them.

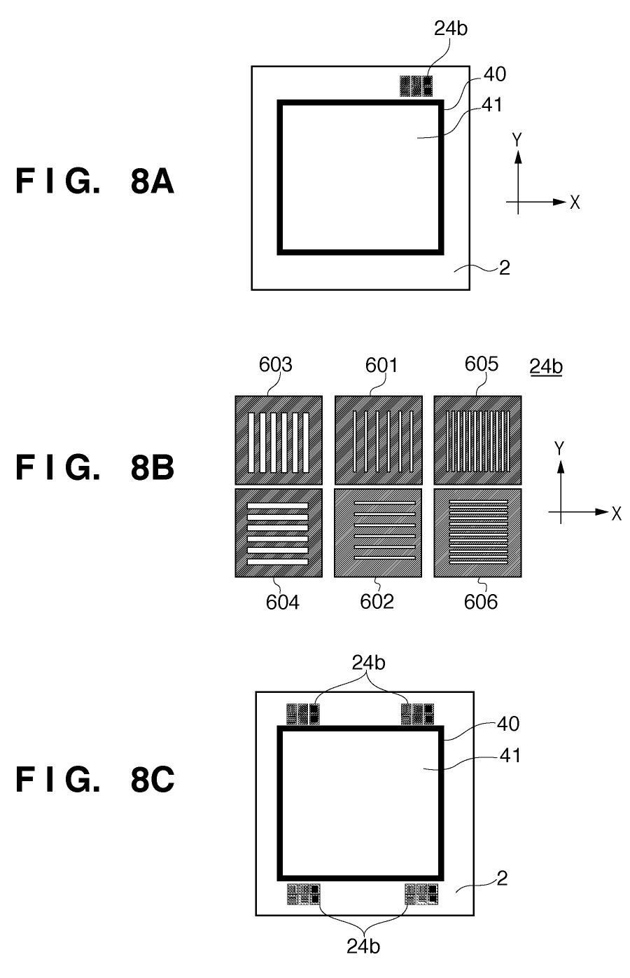

In order to solve these problems, in the second embodiment, a calibration mark group 24b including a plurality of marks having different slit widths and slit intervals, as shown in FIG. 8A, is used to prevent a change in the measurement result obtained by using a reference mark due to poor illumination conditions.

The light amount change profile is optimized by selecting an optimum calibration mark without switching the illumination conditions. This allows improvements in both the throughput and measurement accuracy.

FIG. 8B explains details of the calibration mark group 24b shown in FIG. 8A. Calibration marks 603 and 604 have the same slit intervals as those of calibration marks 601 and 602 as described previously, but have slit widths different from those of the calibration marks 601 and 602. Calibration marks 605 and 606 have the same slit widths as those of the calibration marks 601 and 602, but have slit intervals different from those of the calibration marks 601 and 602. For example, the slit widths and slit intervals of these calibration marks are set as follows:

calibration marks 601 and 602: (slit width)=0.2 μm and (slit interval)=0.8 μm

calibration marks 603 and 604: (slit width)=0.4 μm and (slit interval)=0.8 μm

calibration marks 605 and 606: (slit width)=0.2 μm and (slit interval)=0.4 μm

Note that the slit longitudinal directions of the calibration marks 601, 603, and 605 are the Y direction, and those of the calibration marks 602, 604, and 606 are the X direction.

In other words, the calibration mark group 24b includes a plurality of marks having different slit longitudinal directions, slit widths, and slit intervals. More specifically, the calibration mark group 24b includes a total of six types of calibration marks including slits having two longitudinal directions, that is, the X and Y directions, and three combinations of widths and intervals.

Although a calibration mark group is formed at only one portion in FIG. 8A, the present invention is not particularly limited to this. Also, a plurality of calibration marks need not always be grouped. In other words, the positions and the number of sets of a plurality of calibration marks are not particularly limited. For example, measuring the position of the reference mark at different positions using the same calibration mark makes it possible to measure the tilt, field curvature, magnification, and distortion of the image plane of the projection optical system.

Also, the shapes of the marks are not particularly limited to those shown in FIG. 8B. In other words, a mark shape defined by the slit longitudinal direction and a combination of the slit width and slit interval are not particularly limited.

The effectiveness of this arrangement will be explained in detail next.

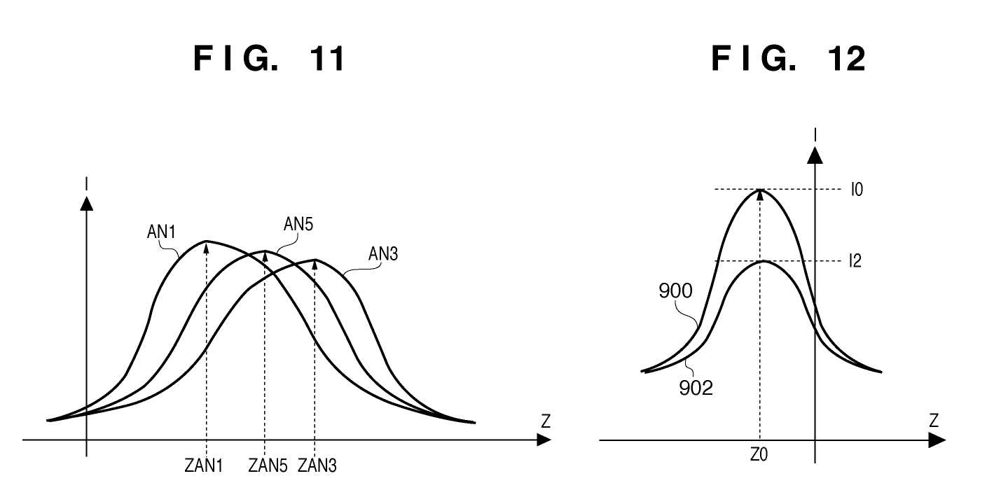

An optimum mark shape is known to change depending on the illumination conditions. For example, the resolution under a low-σ illumination condition is lower than that under a high-σ illumination condition because of a difference in NA. For this reason, in some cases, a light amount change profile 900 is obtained upon high-σ illumination, while a light amount change profile 902 is obtained upon low-σ illumination, as shown in FIG. 12. In other words, the light amount decreases and the detection accuracy deteriorates depending on the illumination conditions. To cope with this situation, the light amount of the light amount change profile 902 can be increased by increasing the slit width, for example, from 0.2 μm to 0.4 μm. This makes it possible to attain an improvement in detection accuracy.

In another example, the light amount under a low-σ annular illumination condition is smaller than that under a high-σ annular illumination condition because of a difference in the amount of light transmitted through a stop S. For this reason, in some cases, a light amount change profile 900 is obtained upon high-σ annular illumination, while a light amount change profile 902 is obtained upon low-σ annular illumination, as shown in FIG. 12. In other words, the light amount decreases and the detection accuracy deteriorates depending on the illumination conditions. To cope with this situation, the light amount of the light amount change profile 902 can be increased by decreasing the slit interval, for example, from 0.8 μm to 0.4 μm. This makes it possible to attain an improvement in detection accuracy.

In still another example, unnecessary diffracted light is generated depending on the illumination conditions. Consequently, the sensor cannot receive the overall amount of light, leading to a decrease in light amount. Even in this case, the light amount of the light amount change profile can be increased by increasing the slit interval, for example, from 0.4 μm to 0.6 μm in the same way as described above. This makes it possible to attain an improvement in detection accuracy.

In still another example, if illumination nonuniformity has occurred, the symmetry of the light amount change profile deteriorates depending on the directions of the marks. For this reason, in some cases, a light amount change profile 900 is obtained by using a 0°-direction mark, while a light amount change profile 901 is obtained by using a 90°-direction mark, as shown in FIG. 9. In other words, the symmetry deteriorates depending on the directions of the marks, leading to a deviation of the detection value. When this occurs, the reference mark is also detected using, for example, the 45°- and 135°-direction marks, and the one having an appropriate direction is selected from them. This makes it possible to attain an improvement in detection accuracy.

Although the slit widths, slit intervals, and mark directions are individually selected for a certain illumination condition in the above description, the present invention is not particularly limited to this. These specifications may be comprehensively selected in accordance with the illumination conditions used, the properties of the marks, and the light amount change profiles.

However, the conventional scheme adds offsets for each illumination condition to the measurement result of the reference mark using the same shape. In order to improve accuracy, it is more preferable to measure the reference mark using a calibration mark having an optimum shape. To select the optimum mark shape, it is necessary to measure calibration marks formed at least at two points on the reticle 2. By storing information which associates respective illumination conditions and calibration marks matching them, and selecting a calibration mark corresponding to the illumination conditions used on the basis of the stored information, the throughput can be improved and the accuracy can be increased. A storage unit of a controller 14 performs the storage, and a control unit of the controller 14 performs the selection.

A selection method will be explained next. A mark shape optimum for the illumination conditions used is determined by individually detecting electrical signals for respective marks from a photoelectric conversion element. Examples of the determination indices of an optimum mark shape are parameters such as the symmetry, peak intensity, and full width at half maximum of a light amount change profile, and the amount of deviation from a reference light amount change profile.

Assume that a light amount change profile 900 shown in FIG. 9 is obtained by measuring the reference mark using the calibration mark 601. The light amount change profile 900 is determined as a reference. Assume also that a light amount change profile 901 is obtained as a result of changing the illumination conditions and measuring the reference mark. The peak position (maximum light amount), for example, of the output value of the light amount change profile 901 at a value Z1 is different from that of the reference light amount change profile 900 at a value Z0. The symmetry, maximum light amount, and full width at half maximum also differ between these light amount change profiles.

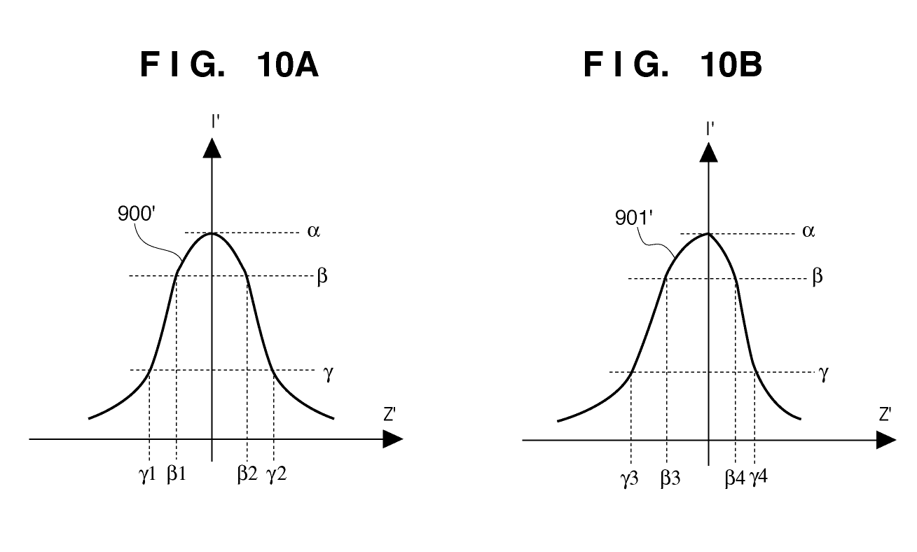

A symmetry determination index Δ will be explained in detail with reference to FIGS. 9 and 10. The intensities of the light amount change profiles 900 and 901 as shown in FIG. 9 are normalized by the intensities for maximum light amounts I0 and I1. Consequently, the light amount change profiles 900 and 901 shown in FIG. 9 shift to light amount change profiles 900′ and 901′ shown in FIGS. 10A and 10B, respectively, as functions between a normalized light amount I′ and a relative position Z′. Note that a normalized maximum light amount α is 1. Referring to FIG. 10A, as for light amounts β to γ (α<β<γ), the position Z′ takes two values β1 and β2 for the relative light amount β. Likewise, the position Z′ takes two values γ1 and γ2 for the relative light amount γ. Then, |β1−γ1|=βγ1 and |βγ1−βγ2|=βγ2 are calculated to define Δ900=|βγ1−βγ2| where the value Δ represents the symmetry. The function Δ is zero for a best symmetry. Conversely, as the symmetry deteriorates, the value Δ becomes farther from zero. Hence, evaluating the value of Δ900 makes it possible to select an optimum mark shape.

Referring to FIG. 10B, Δ901=|βγ3−βγ4| can be calculated from |β3−γ3|=βγ3 and |β4−γ4|=βγ4. Likewise, the reference mark is measured using the calibration marks 603 and 605 under an illumination condition under which a light amount change profile 901 is obtained. Values Δ of the light amount change profiles obtained by measuring the reference mark using the respective calibration marks are calculated. This makes it possible to obtain values Δ, that is, Δ901, Δ903, and Δ905 when different calibration marks 601, 603, and 605, respectively, are used. The comparative evaluation of the values Δ is performed, and the detection result obtained by using a calibration mark with which a value Δ having a smallest absolute value is obtained is determined as the true value for the illumination condition of interest.

For example, if Δ901>Δ903>Δ905, the calibration mark 605 is determined to have an optimum shape.

A concrete example of this determination will be explained with reference to FIG. 11. Assume that a light amount change profile AN1 is obtained by measuring the reference mark using the calibration mark 601 under an annular illumination condition. Assume also that ΔAN1=0.2 in this case. Likewise, assume that light amount change profiles AN3 and AN5 are obtained by using the calibration marks 603 and 605 under the same illumination condition, and ΔAN3=0.15 and ΔAN5=0.05. In this case, since ΔAN1>ΔAN3>ΔAN5, the detection result obtained by measuring the reference mark using the calibration mark 605, in other words, the light amount change profile AN5, is determined as the true value.

Although the absolute values of the values Δ of the light amount change profiles are evaluated herein, these profiles may be evaluated based on their differences in symmetry Δ from the reference light amount change profile 900′. This is because the larger the amount of deviation from the reference light amount change profile, the larger the offset. Hence, the detection result obtained by using a calibration mark with which a value Δ having a smallest amount of deviation from the symmetry index Δ of the reference light amount change profile is determined as the true value for the illumination condition of interest.

The symmetry index Δ is not particularly limited to the above-described equations, and may take any form as long as it can serve to evaluate the symmetry.

The maximum light amounts and full widths at half maximum of the light amount change profiles may also be evaluated by comparing their absolute values or comparing them with the reference light amount change profile.

FIG. 12 shows a light amount change profile 902 having a maximum light amount I2 smaller than the maximum light amount I0 of the reference light amount change profile 900.

The smaller the light amount, the lower its ratio to noise (S/N ratio), resulting in deterioration in the reproducibility of the detection value. For this reason, measuring the reference mark using a calibration mark that generates a relatively high maximum light amount leads to an improvement in detection accuracy. For example, maximum light amounts I, that is, Ia, Ib, and Ic can be obtained when different calibration marks 601, 603, and 605, respectively, are used under the same illumination condition. The comparative evaluation of the values I is performed, and the detection result obtained by using a calibration mark with which a value I having a smallest absolute value is obtained is determined as the true value for the illumination condition of interest.

For example, if Ia>Ib>Ic, the calibration mark 601 is determined to have an optimum shape.

Although the absolute values of the values I of the light amount change profiles are evaluated herein, these profiles may be evaluated based on their differences from the maximum light amount I0 of the reference light amount change profile 900. This is because the larger the amount of deviation from the reference light amount change profile, the larger the offset. Hence, the detection result obtained by using a calibration mark with which a value I having a smallest amount of deviation from the maximum light amount I0 is determined as the true value for the illumination condition of interest.

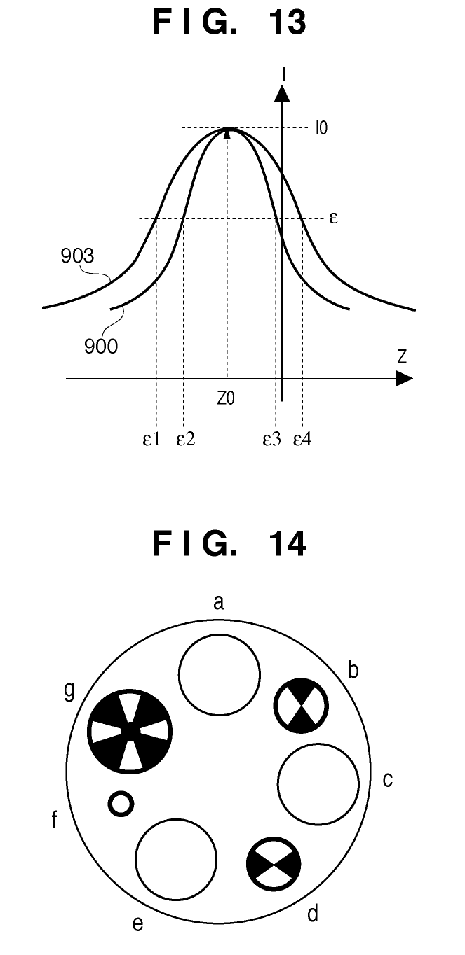

FIG. 13 shows a light amount change profile 903 having a full width at half maximum ε′=|ε1−ε4| wider than a full width at half maximum ε0=|ε2−ε3| of the reference light amount change profile 900.

The wider the full width at half maximum, the poorer the accuracy of position calculation by, for example, barycenter calculation for an error, which may result in deterioration in the reproducibility of the detection value. For this reason, measuring the reference mark using a calibration mark that generates a relatively narrow full width at half maximum leads to an improvement in detection accuracy. For example, full widths at half maximum ε, that is, εa, εb, and εc, can be obtained when different calibration marks 601, 603, and 605, respectively, are used under the same illumination condition. The comparative evaluation of the values ε is performed, and the detection result obtained by using a calibration mark with which a value ε having a smallest absolute value is obtained is determined as the true value for the illumination condition of interest.

For example, if εa>εb>εc, the calibration mark 605 is determined to have an optimum shape.

Although the absolute values of the values ε of the light amount change profiles are evaluated herein, these profiles may be evaluated based on their differences from the peak intensity ε0 of the reference light amount change profile 900. This is because the larger the amount of deviation from the reference light amount change profile, the larger the offset. Hence, the detection result obtained by using a calibration mark with which a value ε having a smallest amount of deviation from the maximum light amount ε0 is determined as the true value for the illumination condition of interest.

Also, the light amount change profile may be evaluated based on a reproducibility σ of the light amount detected at a certain stage position. This reproducibility is involved in the detection accuracy. Reproducibilities σ, that is, σa, σb, and σc, of the detected light amounts can be obtained when different calibration marks 601, 603, and 605, respectively, are used. The comparative evaluation of the values σ is performed, and the detection result obtained by using a calibration mark with which a value σ having a smallest absolute value is obtained is determined as the true value for the illumination condition of interest.

As described above, an optimum mark shape can be evaluated and determined based on the absolute value of the symmetry Δ, maximum light amount value I, or full width at half maximum ε of the light amount change profile, a comparison of these indices with the reference light amount change profile, or the absolute value of the reproducibility σ of the detection value. A combination of these indices may be evaluated.

For example, an optimum mark shape is determined based on a sum S of the weighted values of the absolute values of the indices Δ, I, ε, and σ, or the amount of deviation from the reference light amount change profile. The weighting factor in this case can be arbitrarily determined based on, for example, the properties of the apparatus or the mark group formed.

It is also possible to combine the methods according to the first and second embodiments. That is, the detection results obtained by using the X- and Y-direction marks are evaluated, thereby determining the necessity of measurement. If unnecessary measurement, if any, is omitted, an improvement in throughput and an increase in accuracy can be expected as in the first embodiment.

Not only the light amount change profiles but also the reproducibilities and absolute values of the detection results may be evaluated/compared. For example, a case in which the light amount change profiles are evaluated based on reproducibilities Σ of the detection results will be exemplified. Reproducibilities Σ, that is, Σa, Σb, and Σc, of the detection results can be obtained when different calibration marks 601, 603, and 605, respectively, are used. The comparative evaluation of the values Σ is performed, and the detection result obtained by using a calibration mark with which a value Σ having a smallest absolute value is obtained is determined as the true value for the illumination condition of interest.

A case in which the light amount change profiles are evaluated based on absolute values A of the detection results will be exemplified. Absolute values A, that is, Aa, Ab, and Ac, of the detection results can be obtained when different calibration marks 601, 603, and 605, respectively, are used. The comparative evaluation of the values A is performed, and the detection result obtained by using a calibration mark with which a value A having a smallest difference from that of the reference light amount change profile is obtained is determined as the true value for the illumination condition of interest.

An optimum calibration mark may be selected by evaluating/comparing the magnifications calculated based on the detection results obtained by measuring the reference mark using the same calibration mark.

As shown in FIG. 8C, a plurality of identical calibration mark groups 24b are formed on the X-Y plane of the reticle 2. The magnifications of the projection optical system in the X and Y directions can be obtained based on the results of measuring the reference mark at the positions of the respective calibration marks.

Let Bx be the magnification in the X direction calculated based on the X position detected by measuring a reference mark corresponding to a calibration mark with which the reference light amount change profile is measured, and the position of the calibration mark in the X direction. Magnifications B, that is, Ba, Bb, and Bc, can be similarly obtained by using the calibration marks 601, 603, and 605, respectively under other illumination conditions. The comparative evaluation of the values B is performed, and the detection result obtained by using a calibration mark with which a value B having a smallest amount of deviation from the value Bx is obtained is determined as the true value for the illumination condition of interest.

Although the comparative evaluation of the magnifications in the X direction is performed in the above description, the same applies to the magnifications in the Y direction.

Although the measurement results obtained by using the calibration marks 601, 603, and 605 of a total of six types of calibration marks are compared with that obtained under a reference condition in the above description, the present invention is not particularly limited to this. The number of comparison target calibration marks may be changed in accordance with known illumination conditions or the properties of marks used. An optimum mark shape may be determined not only by comparing the magnitudes of indices but also by setting a certain threshold. The same applies to the selection of a calibration mark used under a reference condition.

The throughput can be further improved by storing mark shapes optimum for respective illumination conditions in the storage unit of the controller 14 and referring to the storage unit, thereby measuring the position of the reference mark using information on a mark shape selected once.

The throughput can also be further improved by selecting, in advance, a mark shape optimum for the illumination conditions used, on the basis of the simulation value of a light amount change profile obtained by measuring the position of the reference mark.

In this embodiment, it is necessary that calibration marks which have different shapes and are arbitrarily formed on the reticle or reticle reference plate can be selected for the illumination conditions used.

### [Method of Manufacturing Device]

Devices (e.g., a semiconductor integrated circuit device and liquid crystal display device) are manufactured by an exposure step of scan-exposing a substrate using the scanning exposure apparatus according to any of the above-described embodiments, a development step of developing the substrate exposed in the exposure step, and other known steps (e.g., etching, resist removal, dicing, bonding, and packaging steps) of processing the substrate developed in the development step.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-335059, filed Dec. 26, 2007, which is hereby incorporated by reference herein in its entirety.

What is claimed is:

1. An exposure apparatus comprising an illumination optical system which illuminates an original with exposure light, a projection optical system which projects an image of the original onto a substrate, an original stage which holds and drives the original, a substrate stage which holds and drives the substrate, and a position detection apparatus which detects a relative position between the original and the substrate,
wherein a plurality of different first marks are formed on at least one of the original and a reference plate held on the original stage, and
the position detection apparatus has a function of selecting a first mark in accordance with an illumination condition from said plurality of first marks, and detecting the relative position between the original and the substrate using the selected first mark and a second mark formed on the substrate stage.

2. The apparatus according to claim 1, wherein each of said plurality of first marks includes at least two first marks each of which includes one or a plurality of slits having at least one of different directions, different dimensions in shorter directions, and different dimensions in longitudinal directions.

3. The apparatus according to claim 1, wherein each of said plurality of first marks includes at least two first marks each of which includes a plurality of slits having at least one of different directions and different intervals.

4. The apparatus according to claim 1, wherein the illumination condition is one of an effective light source and an illumination distribution in an illumination region.

5. The apparatus according to claim 1, further comprising:
a storage unit which stores information which associates the illumination condition with a first mark matching the illumination condition,
wherein the position detection apparatus selects one first mark in accordance with the illumination condition from said plurality of first marks, basec on the information stored in said storage unit.

6. The apparatus according to claim 5, wherein the first mark matching the illumination condition is determined based on at least one of a maximum light amount, full width at half maximum, symmetry, and reproducibility of a profile indicating a change in an amount of light transmitted through said first mark and said second mark upon changing a position of the substrate stage, and an amount of deviation of the light amount change profile from a reference light amount change profile.

7. The apparatus according to claim 5, wherein the first mark matching the illumination condition is determined based on an amount of deviation, from a reference magnification of the projection optical system, of a magnification of the projection optical system obtained from a profile indicating a change in an amount of light transmitted through said first mark and said second mark upon changing a position of the substrate stage.

8. The apparatus according to claim 1, wherein if the illumination condition is dipole illumination, the position detection apparatus selects a first mark including a slit having a longitudinal direction perpendicular to a direction along which two effective illumination regions for the dipole illumination are juxtaposed.

9. A method of manufacturing a device, including steps of
exposing a substrate using an exposure apparatus,
developing the exposed substrate, and
processing the developed substrate,
wherein the exposure apparatus comprises an illumination optical system which illuminates an original with exposure light, a projection optical system which projects an image of the original onto a substrate, an original stage which holds and drives the original, a substrate stage which holds and drives the substrate, and a position detection apparatus which detects a relative position between the original and the substrate,
a plurality of different first marks are formed on at least one of the original and a reference plate held on the original stage, and
the position detection apparatus has a function of selecting a first mark in accordance with an illumination condition from the plurality of first marks, and detecting the relative position between the original and the substrate using the selected first mark and a second mark formed on the substrate stage.

10. A detection method of detecting an image location of light which exits from an illumination optical system which illuminates an original, and is transmitted through a projection optical system which projects an image of the original onto a substrate, the method comprising:
a setting step of setting an illumination condition of the illumination optical system;
a selection step of selecting at least one first mark in accordance with the set illumination condition from a first mark group including a plurality of first marks which have different patterns and are formed on at least one of the original and an original stage which holds the original; and
a detection step of detecting the image location by changing a relative position between the first mark selected in accordance with the set illumination condition and a second mark formed on a substrate stage which holds the substrate, while projecting the pattern of the first mark onto the second mark.

11. The method according to claim 10, wherein
the first mark group includes a first mark which can detect a relative position between the substrate and the original in a first direction on a surface of the substrate, and a first mark which can detect a relative position between the substrate and the original in a second direction which intersects with the first direction on the surface of the substrate,
if dipole illumination is set as the illumination condition in the setting step, the first mark which can detect the relative position in one of the first direction and the second direction is selected in the selection step, and
the relative position between the first mark and the second mark is changed in a direction normal to the surface of the substrate in the detection step.

12. The method according to claim 10, wherein
each of the first marks includes one or a plurality of slits,
the first mark group includes the plurality of first marks including the slits which have identical longitudinal directions and different dimensions in shorter directions,
if a condition under which a value σ is relatively high is set as the illumination condition in the setting step, the first mark including the slit having a relatively small width is selected in the selection step, and
if a condition under which a value σ is relatively low is set as the illumination condition in the setting step, the first mark including the slit having a relatively large width is selected in the selection step.

13. A method of manufacturing a device, comprising:
a detection step of detecting the image location by a detection method defined in claim 10;
an exposure step of exposing the substrate under the illumination condition based on the image location detected in the detection step;
a development step of developing the exposed substrate; and
a processing step of processing the developed substrate.

14. A detection method of detecting an image location of light which exits from an illumination optical system which illuminates an original, and is transmitted through a projection optical system which projects an image of the original onto a substrate, the method comprising:
a setting step of setting an illumination condition of the illumination optical system;
a first selection step of selecting at least one first mark from a first mark group including a plurality of first marks which have different patterns and are formed on at least one of the original and an original stage which holds the original; and
a first detection step of detecting the image location by changing a relative position between the first mark selected in accordance with the set illumination condition in the first selection step and a second mark formed on a substrate stage which holds the substrate, while projecting the pattern of the first mark onto the second mark;
a second selection step of selecting, from the first mark group, at least one first mark different from the first mark selected in the first selection step;
a second detection step of detecting the image location by changing a relative position between the first mark selected in accordance with the set illumination condition in the second selection step and the second mark, while projecting the pattern of the first mark onto the second mark; and
a determination step of determining a true image position for the illumination condition by comparing at least the image location obtained in the first detection step and the image location obtained in the second detection step.

15. A method of manufacturing a device, comprising:
a detection step of detecting the image location by a detection method defined in claim 14;
an exposure step of exposing the substrate under the illumination condition based on the image location detected in the detection step;
a development step of developing the exposed substrate; and
a processing step of processing the developed substrate.
